(19) United States
(12) Patent Application Publication
(10) Pub. No.: US 2014/0201329 A1
(43) Pub. Date: Jul. 17, 2014

(54) DISTRIBUTION OF LAYERED MULTI-MEDIA STREAMS OVER MULTIPLE RADIO LINKS

(71) Applicants: Nageen Himayat, Fremont, CA (US); Vivek Gupta, San Jose, CA (US); Vallabhajosyula S. Somayazulu, Portland, OR (US)

(72) Inventors: Nageen Himayat, Fremont, CA (US); Vivek Gupta, San Jose, CA (US); Vallabhajosyula S. Somayazulu, Portland, OR (US)

(73) Assignee: INTEL CORPORATION, Santa Clara, CA (US)

(21) Appl. No.: 13/976,944

(22) PCT Filed: Jun. 11, 2012
(86) PCT No.: PCT/US12/41930

§ 371 Date: Jun. 27, 2013

(51) Int. Cl. H04L 29/06

(52) U.S. Cl. CPC H04L 65/60
USPC 709/219

(57) ABSTRACT

Embodiments of apparatus, computer-implemented methods, systems, devices, and computer-readable media are described herein for encoding and transmitting layered multi-media streams over multiple radio links. In various embodiments, a first layer of a multi-media stream may be received at a multi-radio computing device through a first radio link. In various embodiments, a second layer of the multi-media stream may be received at the multi-radio computing device through a second radio link. In various embodiments, feedback about the first and second radio links may be transmitted, by the multi-radio computing device through the first or second radio link, to a remote computing device configured to distribute layers of the multi-media stream among the first and second radio links.

### FIELD

Embodiments of the present invention relate generally to the technical field of data processing, and more particularly, to distribution of layered multi-media streams over multiple radio links

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Growth in multi-media traffic, particularly to portable computing devices such as smart phones and tablets, may strain the capacity of various networks, including cellular networks. Many computing devices may have multiple radio interfaces, e.g., a cellular interface and a wireless local area network (“WLAN”) interface, such as a Wi-Fi (IEEE 802.11 family) interface.

Various types of multi-media such as audio (e.g., music, Voice over IP, or “VoIP”) and videos may be delivered in layered streams. For instance, a video stream may be distributed via a relatively low resolution base layer and one or more enhancement layers that may function to enhance the base layer. The base layer may be the most important layer, and therefore may warrant the most reliable transmission mechanisms. For instance, a base layer may provide sufficient data to conduct a low resolution video conference, but may not permit much detail. Enhancement layers, on the other hand, may be given lower priority because while they may enhance the multi-media experience, they may not be essential for basic streaming. A base layer may be combined with one or more enhancement layers to provide increasing video quality along spatial, temporal and quality dimensions. If a client has a weak cellular signal (e.g., in a remote area), the client may choose to receive of base layers over enhancement layers.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example distributed multi-radio network over which a layered multi-media stream may be transmitted, in accordance with various embodiments.

FIG. 2 schematically illustrates an example multi-radio network with an integrated multi-radio radio network access node, in accordance with various embodiments.

FIG. 3 schematically illustrates an example peer-to-peer multi-radio network, in accordance with various embodiments.

FIG. 4 schematically illustrates an example multi-radio network having intermediate nodes with caching capabilities, in accordance with various embodiments.

FIG. 5 schematically illustrates an example of how multi-media may be layered and delivered from a content provider computing device to a multi-radio client computing device, in accordance with various embodiments.

FIG. 6 schematically depicts an example method that may be implemented by a multi-radio client computing device, in accordance with various embodiments.

FIG. 7 schematically depicts an example method that may be implemented by a content provider computing device or an intermediate network node, in accordance with various embodiments.

FIG. 8 schematically depicts an example computing device on which disclosed methods and computer-readable media may be implemented, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

As noted in the background, many computing devices, particularly portable computing devices such as smart phones and tablets, may include multiple radio interfaces. Simultaneous transmission of data over multiple network paths, including to multiple radio interfaces of multi-radio computing devices, may enable exploitation of more bandwidth across increasingly scarce network resources. It may also facilitate increased reliability and/or redundancy.

Layered multi-media streaming applications may utilize so-called “reliable” transport layer protocols such as the Transport Control Protocol (“TCP”), and/or so-called “best effort” transport protocols such as the user datagram protocol (“UDP”). On top of the transport protocol, these applications may use the real-time transport protocol (“RTP,” defined in Request for Comments 3350) for timing and synchronization.

In various embodiments, computing devices receiving a multi-media stream may use the Real Time Control Protocol (“RTCP”) to provide quality of service (“QoS”) feedback related to RTP flows forming the multi-media stream. Receiving computing devices may also use RTCP to synchronize multiple related RTP data flows, e.g., audio and video corresponding to the same multi-media stream. In various embodiments, RTP and RTCP may be used in conjunction with the Real Time Streaming Protocol (“RTSP,” defined in Request for Comments 2326), which may control media delivery and presentation. In various embodiments, the Session Initiation protocol (“SIP,” defined in Request for Comments 3261) may be used to initiate a multi-media stream, and the Session Description Protocol (“SDP,” defined in Request for Comments 4566) may be used to describe characteristics of a multi-media stream.

A layered multi-media stream may include multiple layers. For instance, as noted in the background, a layered video stream may include base layers and enhancement layers. In various embodiments, the H.264 Advanced Video Coding (“AVC”) standard may be used for video recording, compression and distribution of video, including high definition (“HD”) video.

The H.264 Scalable Video Coding (“SVC”) standard is an extension of the H.264 AVC standard that may provide layering capabilities to H.264 AVC. SVC may also enable post-encode bit-rate adaptation through layer selection and pruning. Consistent with the overall H.264 approach of providing a video coding layer (“VCL”) and a separate network adaptation layer (“NAL”), SVC may define NAL packet header extensions that identify the key scalability characteristics of each packet carrying encoded video. Request for Comments 6190 describes payload formats that may allow for inclusion of SVC NAL units in RTP packets. Among other things, the RTP payload format may facilitate transmission of an SVC coded video over both single and multiple sessions (e.g., RTP sessions). This may preserve backward compatibility with H.264 AVC since a base layer of a video stream may be encapsulated in its own RTP stream using, e.g., RTP payload format for H.264 video described in Request for Comments 6184.

These various protocols (e.g., SVC, RTP, RTCP, SIP, SDP) may be utilized as described herein to facilitate efficient and/or reliable end-to-end transport of layered multi-media streams over multi-radio networks. The control and delivery mechanisms and techniques described herein may be used in various configurations of multi-radio networks.

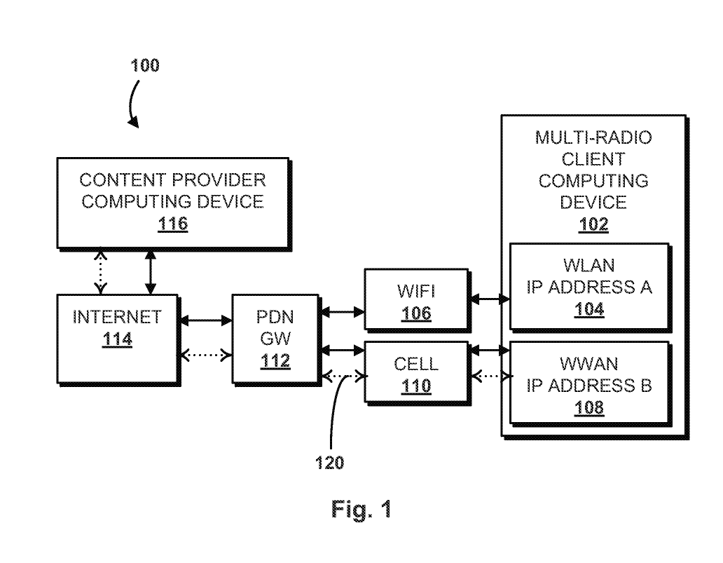

A first configuration 100 of a multi-radio network is depicted schematically in FIG. 1. The configuration 100 may be referred to as a “distributed” configuration because there may be no coupling between different access networks on the infrastructure. A multi-radio client computing device 102 may include a first radio interface 104 to a first type of radio network. In FIG. 1, first radio interface 104 is a wireless local area network (“WLAN”) interface, though this is not required. In various embodiments, first radio interface 104 may include an antenna. First radio interface 104 may exchange data over radio waves with a first radio network access node 106, shown in FIG. 1 as a Wi-Fi (IEEE 802.11 family, referred to as “WiFi” herein) access point. Multi-radio client computing device 102 may also include a second radio interface 108, shown in FIG. 1 as a cellular wireless wide area network (“WWAN”) interface. In some embodiments, second radio interface 108 may include an antenna to communicate with another radio network access node 110, shown in FIG. 1 as a cellular node (labeled “CELL”). In various embodiments, radio network access node 110 may be various types of WWAN access points, such as a Node B, an evolved Node B (“eNB”), a femto eNB, a WiMAX (IEEE 802.16 family) base station, and so forth. Multi-radio client computing device 102 may be various types of devices, such as a smart phone, tablet, laptop computer, set-top box, gaming console, and so forth.

In various embodiments, such as the embodiment depicted in FIG. 1, first radio interface 104 and second radio interface 108 may have two separate addresses, such as IP address A and IP address B. However, this is not meant to be limiting, and as will be described below, in some embodiments, multiple radio interfaces on a client device may share a single IP address.

Although separate, in various embodiments, radio network access nodes 106 and 110 may be part of a single operator-managed network. In various embodiments, radio network access nodes 106 and 110 may be separately connected to a packet data network (“PDN”) gateway (“GW”) 112. In various embodiments, PDN GW 112 may be connected through one or more local area and wide area networks, such as the Internet 114, to a content provider computing device 116. Content provider computing device 116 may be various types of computing devices, such as a server computing device, a desktop or laptop computer, or any other device that may be configured to encode and/or distribute a video stream to one or more multi-radio client computing devices (e.g., 102).

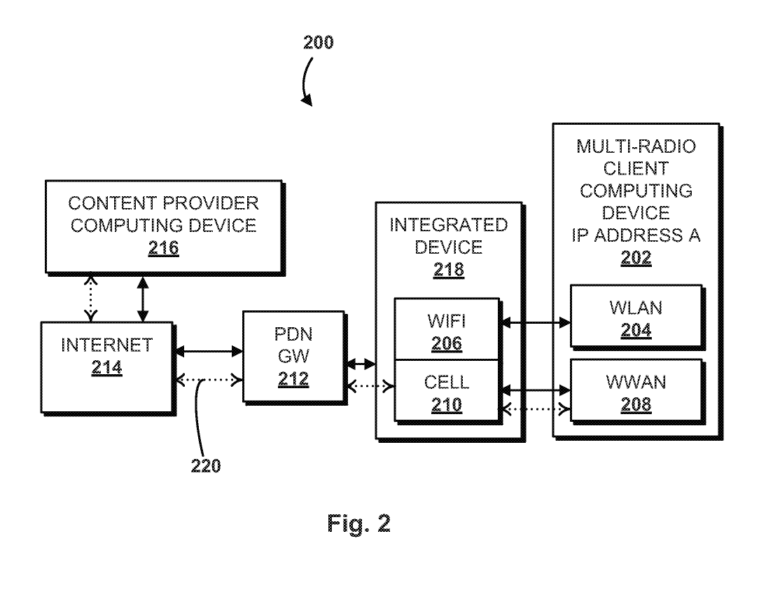

A second configuration 200 of multi-radio network architecture is depicted schematically in FIG. 2. Most of the components in FIG. 2 are similar to those in FIG. 1. A multi-radio client computing device 202 may include a first radio interface 204 (shown as WLAN) and a second radio interface 208 (shown as WWAN) which may be in communication with a first radio network access node 206 and a second radio network access node 210, respectively. However, the configuration 200 differs from that of FIG. 1 because multiple radio network access nodes for multiple types of radio networks may act in cooperation, and in some cases may be part of a single computing device. For instance, in FIG. 2, first and second radio network access nodes 206 and 210 are combined into an integrated radio network access node 218. Thus, first and second radio network access nodes 206 and 210 may have a single connection to a PDN GW 212, which in turn may be connected through the Internet 214 to a content provider computing device 216. In this example, multi-radio client computing device 202 may have a single IP address for both first radio interface 204 and second radio interface 208, though this is not required. In various embodiments, integrated radio network access node 218 may utilize radio resource control (“RRC”) to map layers of a multi-media stream (e.g., SVC layers of a video stream) across multiple radio links, e.g., to first radio interface 204, second radio interface 208, based on feedback from multi-radio client computing device 202.

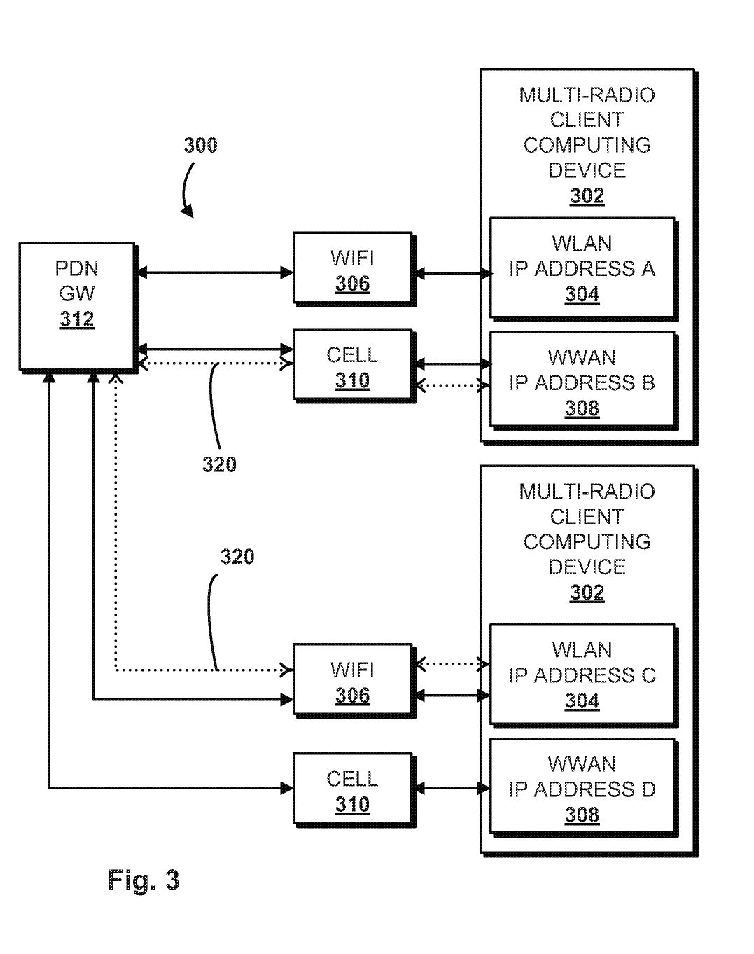

A third multi-radio network configuration 300 is depicted schematically in FIG. 3. The configuration 300 may be described as “peer-to-peer” because at least one multi-radio client computing device 302 itself acts as a content server. This configuration may apply, for instance, when users communicate using video chat. Multiple radio network access nodes 306 and 310 may connect multiple multi-radio client computing devices 302. In some embodiments, multi-radio client computing devices 302 may be configured to communicate directly with each other without any intermediate nodes (e.g., without PDN GW 312 or radio network access nodes 306/310). In the embodiment of FIG. 3, first radio interface 304 and second radio interface 308 on each multi-radio client computing device 302 has its own IP address, but this is not required.

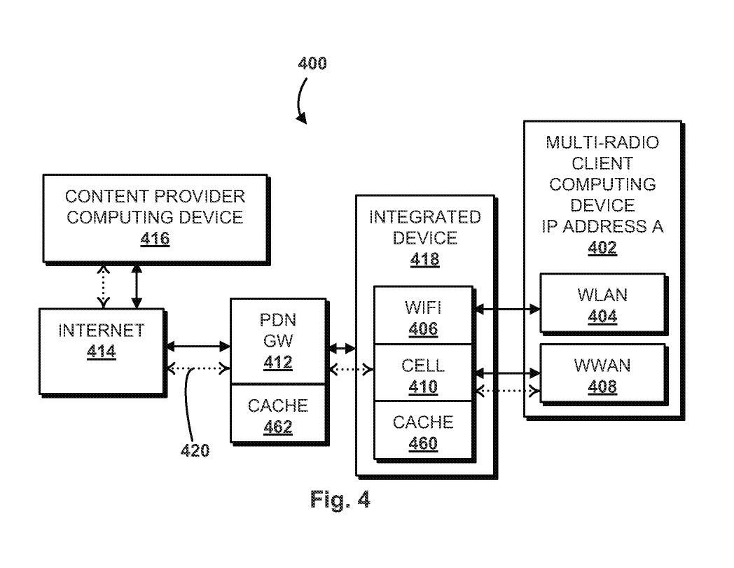

Other nodes of a multi-radio network infrastructure may also operate as content providers. FIG. 4 shows one such example configuration 400. Most of the components are similar to those shown in FIGS. 1 and 2, and will not be described again. However, in this example, integrated radio network access node 418 may include cache memory 460 for caching local layered multi-media data for delivery to multi-radio client computing device 402. Similarly, PDN GW 412 may also include cache memory 462 for caching local layered multi-media data for delivery to integrated radio network access node 418. In some embodiments, integrated radio network access node 418 and/or PDN GW 412 may include logic (not shown) for mapping layers of a multi-media stream across multiple radio links (e.g., to first radio interface 404 and/or second radio interface 408), based on feedback from multi-radio client computing device 402. In some embodiments, a femto node such as an integrated LTE/Wifi station may also be configured to map layers of a multi-media stream across multiple radio links. As another example, a “home agent” serving as a mobility anchor for multiple connections may also be configured to map layers of a multi-media stream across multiple radio links.

Layered multi-media streams may be transmitted from a content provider computing device (e.g., 116, 216, 302, 416) to a multi-radio client computing device (e.g., 102, 202, 302, 402) over the various architectures shown in FIGS. 1-4 in various ways. Referring to FIG. 1, in some embodiments, multi-radio client computing device 102 and content provider computing device 116 may utilize a proprietary protocol to facilitate transmission of a layered multi-media stream from content provider computing device 116 to multi-radio client computing device 102. Other embodiments may utilize non-proprietary protocols, such as RTCP and SDP.

Single or multiple sessions may be established between the content provider computing device (e.g., 116, 216, 302, 416) and multi-radio client computing device (e.g., 102, 202, 302, 402) for transmission of layered multi-media streams. For example, multi-radio client computing device 102 may utilize protocols such as SIP and SDP to establish a single session (e.g., an RTP session) with content provider computing device 116 for transmission of a layered multi-media stream. In various embodiments, the session may be initiated using SIP and described using SDP. Multi-radio client computing device 102 may also establish multiple sessions (e.g., RTP sessions) with content provider computing device 116 for transmission of the layered multi-media stream. Content provider computing device 116 may then adjust and/or map layers of a multi-media stream (e.g., H.264 SVC layers) across the multiple RTP sessions based on feedback received from multi-radio client computing device 102.

In various embodiments, packets of a particular session (e.g., an RTP session) may be transmitted by content provider computing device (e.g., 116, 216, 302, 416) to a single IP address (e.g., a single UDP/IP session) or to multiple IP addresses (e.g., multiple UDP/IP sessions), e.g., at first radio interface 104 and second radio interface 108. For example, SVC may be used to map multiple layers of a video stream, such as a base layer and one or more enhancement layers, to first radio interface 104 and second radio interface 108. In various embodiments, an SDP “connection descriptor” may be configured to specify multiple unicast IP addresses for a single session, e.g., an RTP session.

Referring to FIG. 1, in various embodiments, a control link 120 (shown in dashed lines in FIG. 1) may be established between content provider computing device 116 and multi-radio client computing device 102. As noted above, various protocols, such as proprietary protocols or other protocols described herein, may be used to establish and/or exchange information over control link 120. Control link 120 may be established through either of first radio interface 104 or second radio interface 108 based on various criteria, such as which radio link is more reliable. Control link 120 may be used to exchange control information about the multiple radio links and/or multi-radio client computing device 102. Control information sent from multi-radio client computing device 102 to content provider computing device 116 may be referred to as “feedback.”

In various embodiments, feedback may include but is not limited to information about link quality, quality of experience (“QoE”), IP connectivity among multiple links, capabilities of multi-radio client computing device 102 (e.g., supported display resolutions), as well as other information, such as a number of multi-media stream layers requested by multi-radio client computing device 102, and/or a requested resolution and/or data rate per layer of the multi-media stream.

In various embodiments, multi-radio client computing device 102 may establish control link 120 with content provider computing device 116 over various types of IP-based connections, such as a UDP/IP or TCP/IP connection. In various embodiments, a TCP connection may be used for reliable delivery. A UDP connection, which may be combined with another protocol such as RTP, may enable faster feedback. Control links 220, 320 and 420, similar to control link 120, may be established in the multi-radio network configurations shown in FIGS. 2, 3 and 4, respectively.

In FIG. 3, control link 320 may be established between various hops of the network in various ways. For instance, the bottom multi-radio client computing device 302 has a control link through the first radio network access node 306, which is WiFi in FIG. 3, to PDN GW 312. In contrast, the control link 320 between the top multi-radio client computing device 302 and PDN GW 312 is through a second type of radio access node, in this cause a cellular node. In any case, feedback may be sent by the receiving multi-radio client computing device 302 to the sending multi-radio client computing device 302 over control link 320.

Referring back to FIG. 1, content provider computing device 116 may determine how many multi-media stream layers (e.g., SVC video stream layers) to create, based on feedback received from multi-radio client computing device 102 over control link 120. Content provider computing device 116 may also map the layers of the multi-media stream across distinct UDP or TCP flows (e.g., to first radio interface 104 and/or second radio interface 108), based on feedback received from multi-radio client computing device 102 over control link 120. For example, content provider computing device 116 may adjust and map multiple video stream layers across distinct UDP/IP flows based on per-link feedback received from multi-radio client computing device 102 via RTCP. In various embodiments, feedback may include layer 2 information that may be transmitted, e.g., using extension fields of an application layer RTCP packet. In various embodiments, extension fields of application layer RTCP packets may also be used for support for video QoE metrics.

Referring to FIG. 2, different mechanisms and protocols may be utilized where an integrated radio network access node 218 facilitates two different types of radio links, e.g., WiFi 206 and cellular 210. As noted above, in this example, multi-radio client computing device 202 may have only a single IP address for both first radio interface 204 and second radio interface 208. In such embodiments, content provider computing device 216 may be unaware of the multiple radio links. Instead, content provider computing device 216 may only create and adjust the layers of the multi-media stream, e.g., for transmission via a single session (e.g., a single H.264/RTP/UDP/IP session) destined for the single IP address of multi-radio client computing device 202. Integrated radio network access node 218 may be configured to map the layers across radio links, e.g., to first radio interface 204 and second radio interface 208.

Multi-radio client computing device 202 may return feedback over control link 220 using various protocols already discussed, such as proprietary protocols, RTP, RTCP, and so forth. In some cases, the feedback may not control the mapping of video stream layers across multiple radio links, and therefore, it may not be necessary to include in the feedback layer 2 information such as link quality or IP connectivity among multiple links.

To map layers of a multi-media stream across multiple radio links, integrated radio network access node 218 may be configured to perform “deep packet inspection.” In some embodiments, integrated radio network access node 218 may inspect headers and/or payloads of incoming packets (e.g., NAL packets) addressed to the single IP address of multi-radio client computing device 202. Based on this inspection and on feedback received from multi-radio client computing device 202, integrated radio network access node 218 may map distinct layers, e.g., SVC layers, to different radio links. In some embodiments, RTP header extensions may be used to indicate the priority level of various packets, such as RTP packets (e.g., a base layer may be given higher priority than enhancement layers). In embodiments where multiple sessions (e.g., RTP sessions) are used to transmit multiple video stream layers to a single IP address, as may be the case in FIG. 2, integrated radio network access node 218 may inspect session packet headers to screen layers (e.g., SVC layers).

In various embodiments, RTP header extensions may be utilized to indicate the number of total layers (e.g., base layer plus enhancement layers) in the video stream. Use of RTP header extensions in this manner may also facilitate real-time updating and dynamic adjustment of the number of total video stream layers, which may assist with synchronization, decoding and reconstructing the entire video stream at multi-radio client computing device 202 and avoid packet drops and/or delays.

Both layered multi-media stream providers (e.g., content provider computing devices 116, 216, 302, 416) and layered multi-media stream clients (e.g., multi-radio client computing devices 102, 202, 302, 402) may be configured to perform additional operations in order to practice disclosed techniques. On the client side, multi-radio client computing devices (e.g., 102, 202, 302, 402) may be configured to reconstruct and decode video streams received across multiple radio interfaces (e.g., 104, 108, 204, 208, 304, 308, 404, 408). In various embodiments, one or more playback buffer queues (not shown) at a multi-radio client computing device may be sized according to a maximum packet delay that may be experienced across multiple radio links. For example, buffer queues for high quality/resolution layers with high throughput links may be larger than buffer queues for lower quality/resolution layers or with lower throughput on links.

On the sender side, cross layer and cross link design may also be examined to select a suitable number of video stream layers, bit rates of each layer, and the mappings of each layer to radio links. For instance, when a content provider computing device (e.g., 116, 216, 302, 416) or radio network access node (e.g., 218, 418) learns about network congestion or changing link conditions, it may be configured to reduce a bit rate of a video stream layer over a particular link. Additionally or alternatively, a number of layers or a type of layers transmitted over a particular radio link may be adjusted, e.g., to balance loads on different radio links. In some embodiments, a lower resolution/bit rate layer such as a base layer may be statically mapped to the most reliable transmission link, e.g., a cellular link (e.g., 110, 210, 310, 410). A number of enhancement layers may be adjusted to be sent across the most opportunistic best effort links, based on link conditions. In various embodiments, particularly those that implement techniques described in Request for Comments 6190, there may be sufficient flexibility to support layer mapping and adaptation at the IP level, without precluding support for layer mapping and adaptation at lower levels, such as at a radio link layer.

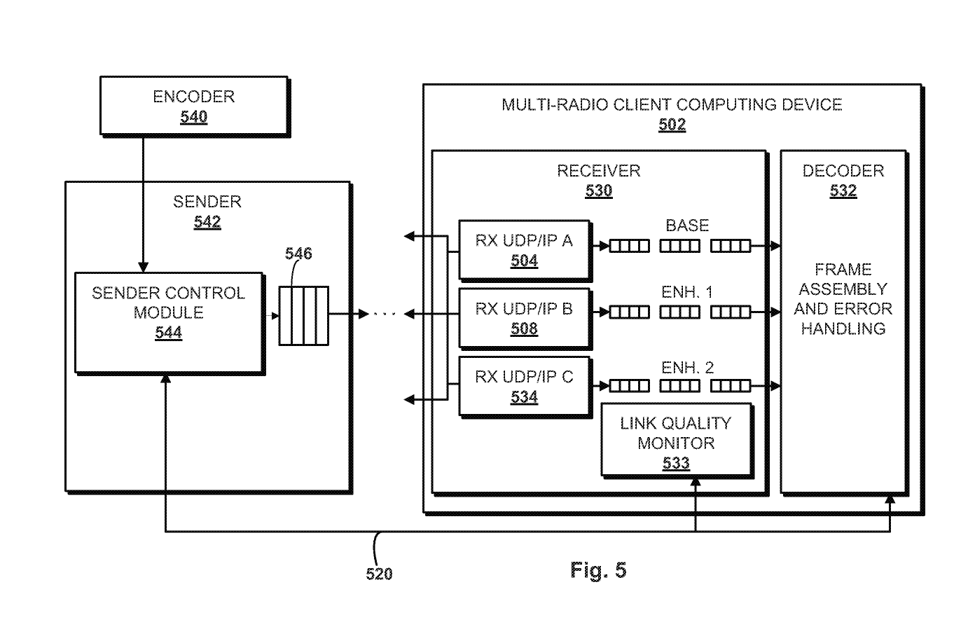

Referring now to FIG. 5, a manner of sending/receiving multiple layers of a multi-media stream is demonstrated in detail. A multi-radio client computing device 502 may include a receiver 530, a decoder 532 and a link quality monitor 533. In various embodiments, multi-radio client computing device 502 may include a number of radio interfaces, such as a first radio interface 504, a second radio interface 508 and a third radio interface 534. In various embodiments, link quality monitor 533 may monitor the quality of one or more radio links, e.g., radio links to which radio interfaces 504, 508 and 534 are connected. Link quality monitor 533 may be in communication with decoder 532, and together they may contribute information that may ultimately be included in feedback provided by multi-radio client computing device 502 to a sender 542, e.g., over control link 520.

An encoder 540 may be part of a content provider computing device (e.g., 16, 216, 302, 416), a radio network access node (e.g., 216, 416), or any other network node (e.g., a femto eNB) configured to encode multi-media content (e.g., audio, video) into a layered multi-media stream. After encoding, encoder 540 may send the layers of the multi-media stream (e.g., NAL units) to a sender 542 for distribution/mapping among multiple radio links to multi-radio client computing device 502.

Sender 542 may be part of a content provider computing device (e.g., 116, 216, 302, 416), a radio network access node (e.g., 216, 416), or any other network node (e.g., a femto eNB) configured to distribute/map layers of a layered multi-media stream among multiple radio links, e.g., to first radio interface 504, second radio interface 508 and/or third radio interface 534. In embodiments such as those shown in FIGS. 1 and 3, encoder 540 and sender 542 both may operate on the same computing device, e.g., a content provider computing device (e.g., 116, 302). In embodiments such as those chose in FIGS. 2 and 4, encoder 540 may operate on a content provider computing device (e.g., 116, 302), and sender 542 may operate on a separate computing device closer to the ultimate recipient, such as an integrated radio network access node (e.g., 218, 418).

In various embodiments, sender 542 may include a sender control module 544 configured to map multi-media layers across various radio links. In various embodiments, sender control module 544 may be implemented in software, hardware, firmware, or any combination thereof. Encoder 540 may provide layers of a layered multi-media stream (e.g., NAL units such as base layers and/or enhancement layers) to sender control module 544. Sender control module 544 may map the layers to another protocol, such as RTP. Sender control module 544 may further map the RTP packets to one or more transport level protocols (e.g., TCP/IP and/or UDP/IP). Sender control module 544 may then send the mapped units to a send queue 546, which in turn may be transmitted to a next hop towards multi-radio client computing device 502.

As indicated by the three dots in between sender 542 and multi-radio client computing device 502, any number of networks and network nodes may lie between these two devices. In embodiments where sender 542 is implemented on a radio network access node (e.g., 218, 418) that directly connects to radio interfaces 504, 508, 534 of multi-radio client computing device 502, sender 542 may include separate radio interfaces (not shown) that correspond to radio interfaces 504, 508 and 534.

Once packets arrive at the radio interfaces of receiver 530 (e.g., 504, 508, 534), the packets may be organized into sorted (e.g., time-stamped) frame buffers. In FIG. 5, the packets arriving over first radio interface 504 may form a base layer of a video stream, which suggests (but does not require) that first radio interface 504 may be the most reliable radio interface. The packets arriving over second radio interface 508 and third radio interface 534 may form enhancement layers of the video stream, which suggests (but does not require) that second radio interface 508 and third radio interface 534 may be less reliable than first radio interface 504. Decoder 532 may receive the packets from the various frame buffers and may assemble the frames and handle errors.

There may be a variety of errors that may occur in complex systems such as the multi-radio networks described herein. Thus, various error detection and correction mechanisms may be implemented at various network nodes.

In various embodiments, end-to-end delay may be bounded. If packets/frames are delayed at sender 542 beyond a certain threshold, the packets may be discarded. In various embodiments, this may be done by attaching time-to-live (TTL) markers to packets in send queue 546, e.g., at sender 542. Similarly, if some packets of a frame are not received at receiver 530 before a predetermined amount of time expires (e.g., from receiving a first packet of the frame), the packets of the frame that did arrive may be discarded. In some embodiments, receiver 530 may request that sender 542 resend that frame.

To discard base layer versus enhancement layer packets at the sender, a scheduler (not shown) may monitor link quality and network throughputs. In embodiments with integrated radio network access nodes, such as the embodiment shown in FIG. 2, the scheduler may adopt per-packet scheduling decisions access the available radio carriers in order to optimize QoE. For instance, if most of the packets of a particular video frame have been transmitted but the last packet is in danger of being dropped (e.g., due to congestion, link quality, etc.), then the scheduler may transmit the packet on another wireless link to ensure that the multi-radio client computing device (e.g., 102, 202, 302, 402, 502) does not discard a number of video frame packets that have already been received and suffer downgraded QoE as a result. In some embodiments, particularly where visibility is available across multiple pipes, more than one intermediate node may schedule multi-media stream layers from a content provider to a client.

In various embodiments, packets may arrive at receiver 530 out of sequence, as well as on different radio interfaces. This may make it difficult to predict packet arrival sequences. When packets are dropped by receiver 530, the frame may not be constructed appropriately. Accordingly, in various embodiments, packet arrivals for different frames may be monitored, and based on that information, receiver 530 or other components may determine that a packet of the frame is lost, and may send feedback to sender 542 to discard the frame. In various embodiments, RTCP immediate feedback may be used for this feedback. In various embodiments, errors in the feedback channel itself (e.g., control link 120, 220, 320) also may be detected and handled.

To ensure that changes in multi-media stream encoding (e.g., due to changes in link quality) are communicated between sender 542 and receiver 530, water marks and other stream metrics may be used. Sender 542 and/or receiver 530 may make appropriate tradeoffs between a suitable number of enhancement layers to use, quality/resolution of content on each layer, number of links to use, how many layers to send over each link, etc. Using more links and greater number of enhancement layers may enable more flexibility to provide higher overall content quality, but may increase system overhead, particularly in terms of additional transport channels, greater synchronization efforts and sensitivity to system and network errors.

In addition to the network configurations and techniques described herein other configurations and techniques are contemplated. For example, while most of the embodiments described herein have utilized unicast sessions, the disclosed techniques may be equally applicable to multi-cast sessions across multiple radio links. Additionally, in various embodiments, a layered multi-media stream may be delivered by optimized Content Delivery Networks, or “CDNs,” at an edge of one or more networks, or through other special gateways such as high-speed residential/enterprise gateways. In some embodiments, such elements may collect near-term radio link feedback across multiple radio networks and then partition multi-media layers across different networks at the IP level or higher. This configuration may also be used in conjunction with various 3GPP network features, so that it may be possible to handover or switch flows of individual multi-media layers to different access networks with minimal perceived user impact. Additionally, Disclosed techniques may be used for various applications, including but not limited to video conferencing, broadcast of live/stored content over mobile networks, streaming audio, streaming video, and so forth.

Various specific technologies and protocols are mentioned in relation to the various embodiments described herein. However, this is not meant to be limiting, and various other technologies and protocols may be used instead. For example, protocols that are more or less reliable than UDP, such as TCP, may be substituted in any instance where UDP is mentioned as being used. As another example, H.264 SVC layering of video streams is mentioned repeatedly herein, but any scalable multi-media distribution schemes may be used on any type of multi-media stream.

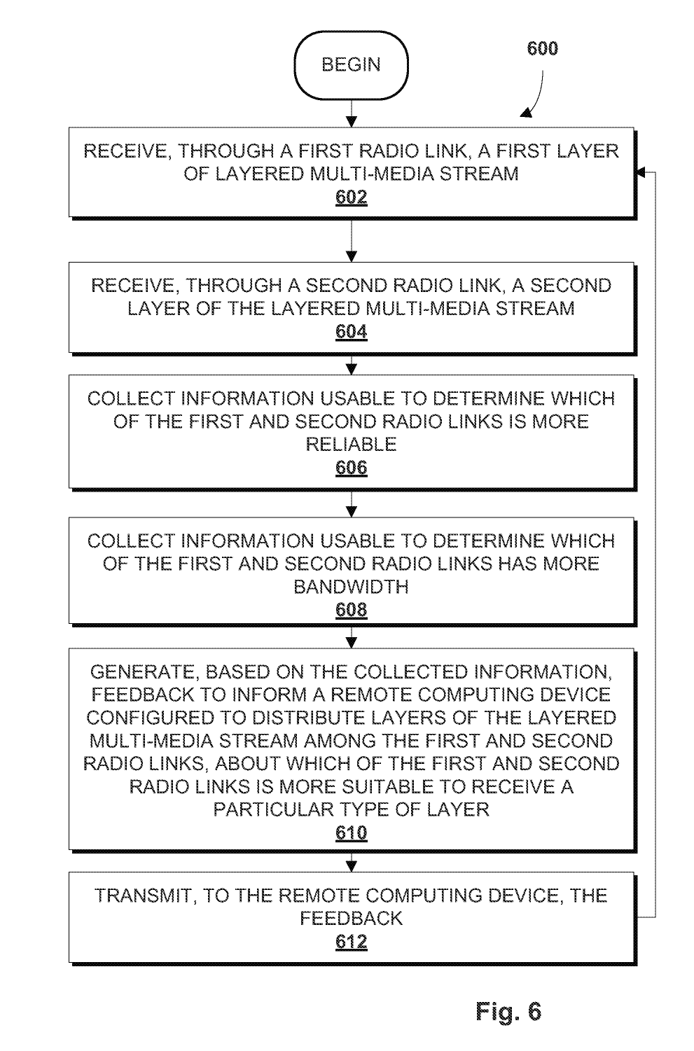

FIG. 6 depicts an example method 600 that may be implemented on a multi-radio client computing device (e.g., 102, 202, 302, 402, 502), in accordance with various embodiments. At block 602, a first layer of a layered multi-media stream such as a SVC video stream may be received, e.g., by the multi-radio client computing device, through a first radio link. At block 604, a second layer of the layered multi-media stream may be received, e.g., by the multi-radio client computing device, through a second radio link.

At block 606, information usable to determine which of the first and second radio links is more reliable may be collected, e.g., by the multi-radio client computing device. At block 608, information usable to determine which of the first and second radio links has more bandwidth may be collected, e.g., by multi-radio client computing device.

At block 610, feedback may be generated, e.g., by the multi-radio client computing device, based on the collected information, and/or based on other information described above (e.g., device capabilities, QoE metrics, etc.). In various embodiments, this feedback may inform a remote computing device configured to distribute layers of the layered multi-media stream among the first and second radio links, such as a content provider computing device (e.g., 116, 216, 302, 416, 516), an integrated radio network access node (e.g., 218, 418), or other network nodes (e.g., femto eNBs), about which of the first and second radio links is more suitable to receive a particular type of layer of the layered multi-media stream. For example, the feedback may inform the remote computing device about which radio link is more reliable, and therefore should be used to transport a base layer of a layered video stream. Additionally or alternatively, the feedback may inform the remote computing device about which radio link has more bandwidth, and therefore should be used to transport enhancement layers of a layered video stream (which may in some cases include more data than base layers).

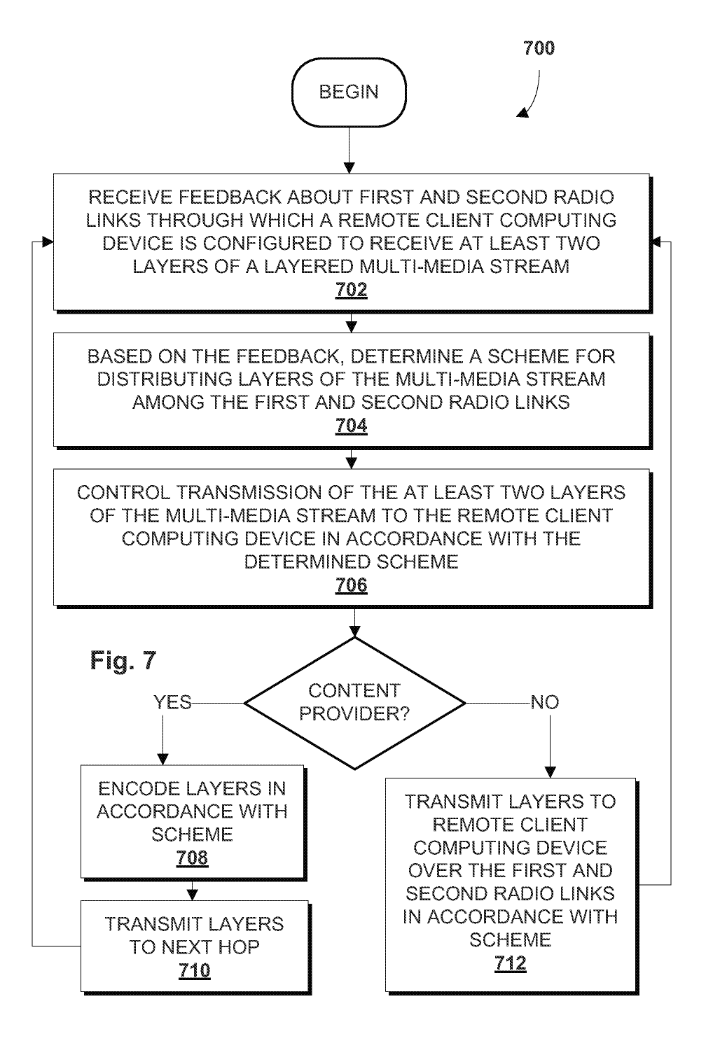

At block 612, the generated feedback may be transmitted, e.g., by the multi-radio client computing device, to the remote computing device. As described above and shown in FIG. 7, the remote computing device may utilize this feedback to control how the layered multi-media stream is delivered to the multi-radio client computing device over multiple radio links. If the remote computing device is a content provider, it may adjust how many and what types of layers are created. Regardless of whether the remote computing device is a content provider or an intermediate network node, it may also determine how to distribute the created layers among the first and second radio links. As shown by the arrow, the method 600 may then proceed back to block 602, unless delivery of the multi-media stream is complete (or otherwise stopped), in which case method 600 may end.

FIG. 7 depicts an example method 700 that may be implemented by a sender control module (e.g., 544), in accordance with various embodiments. As noted above, sender control module 544 may be implemented on a content provider computing device (e.g., 116, 216, 302, 416, 516) or other intermediate network nodes, such as an integrated radio network access node (e.g., 218, 418), or even a multi-radio client computing device (e.g., 302) that wishes to transmit, peer-to-peer, a multi-media stream to another multi-radio client computing device (e.g., 302), as shown in FIG. 3.

At block 702, feedback about first and second radio links through which a remote client computing device, such as a multi-radio client computing device (e.g., 102, 202, 302, 402, 502), is configured to receive at least two layers of a layered multi-media stream, may be received. In various embodiments, this feedback may be received over a control link (e.g., 120, 220, 320, 420, 520).

At block 704, based on the received feedback, a scheme may be determined for distributing layers of the multi-media stream among the first and second radio links. For example, sender control module 544 may determine from the feedback that a first radio link (e.g., to a radio interface of a multi-radio client computing device) is more reliable, and therefore may be better-suited for the receipt of a base layer of a layered video stream. As another example, sender control module 544 may determine from the feedback that a first radio link has more bandwidth, and therefore may be better-suited for receipt of one or more high resolution (e.g., enhancement) layers of a layered video stream. At block 706, transmission of the at least two layers of the multi-media stream may be controlled, e.g., by a content provider computing device (e.g., 116, 216, 302, 416, 516) or integrated radio network access node (e.g., 218, 418), in accordance with the scheme determined at block 704. Controlling transmission (i.e., block 706) may involve various additional operations, depending on whether the device or system performing method 700 is a content provider or another network node. If a content provider, then at block 708, layers of the multi-media stream may be encoded in accordance with the scheme. For instance, an encoder (e.g., 540) operating on the content provider (e.g., 116, 216, 302, 416) may encode a video stream into a base layer and one or more enhancement layers. At block 710, the content provider may transmit the encoded layers to the next hop towards the ultimate recipient, e.g., the multi-radio client computing device (e.g., 102, 202, 303, 402, 502). If, however, the computing device performing method 700 is not the content provider, then at block 712, the layers may be transmitted to the remote client computing device over the first and second radio links in accordance with the scheme determined at block 704. In either case, method 700 may proceed back to block 702, unless delivery of the multi-media stream is complete (or otherwise stopped), in which case method 700 may end.

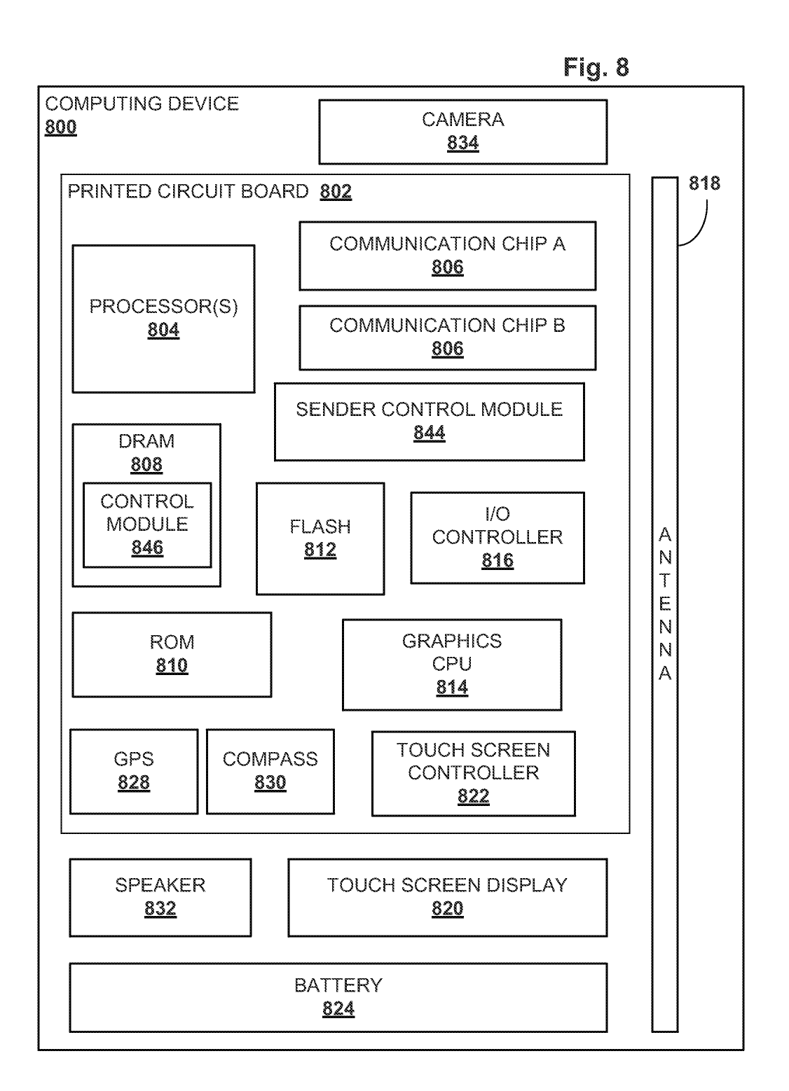

FIG. 8 illustrates an example computing device 800, in accordance with various embodiments. Computing device 800 may include a number of components, a processor 804 and at least one communication chip 806. In various embodiments, the processor 804 may be a processor core. In various embodiments, the at least one communication chip 806 may also be physically and electrically coupled to the processor 804. In further implementations, the communication chip 806 may be part of the processor 804. In various embodiments, computing device 800 may include printed circuit board (“PCB”) 802. For these embodiments, processor 804 and communication chip 806 may be disposed thereon. In alternate embodiments, the various components may be coupled without the employment of PCB 802.

Depending on its applications, computing device 800 may include other components, such as one or more of the platform entities discussed herein, that may or may not be physically and electrically coupled to the PCB 802. These other components include, but are not limited to, volatile memory (e.g., dynamic random access memory 808, also referred to as “DRAM”), non-volatile memory (e.g., read only memory 810, also referred to as “ROM”), flash memory 812, a graphics processor 814, a digital signal processor (not shown), a crypto processor (not shown), an input/output (“I/O”) controller 816, one or more antenna 818 (e.g., two or more antennas in some embodiments where computing device 800 is a multi-radio client computing device), a display (not shown), a touch screen display 820, a touch screen controller 822, a battery 824, an audio codec (not shown), a video codec (not shown), a global positioning system (“GPS”) device 828, a compass 830, an accelerometer (not shown), a gyroscope (not shown), a speaker 832, a camera 834, and a mass storage device (such as hard disk drive, a solid state drive, compact disk (“CD”), digital versatile disk (“DVD”))(not shown), and so forth. In various embodiments, the processor 804 may be integrated on the same die with other components to form a System on Chip (“SoC”). In embodiments where computing device 800 maps layers of a multi-media stream to multiple radio links, computing device 800 may further include a sender control module 844.

In various embodiments, volatile memory (e.g., DRAM 808), non-volatile memory (e.g., ROM 810), flash memory 812, and the mass storage device may include programming instructions configured to enable computing device 800, in response to execution by processor(s) 804, to practice all or selected aspects of method 600 and/or 700. For example, one or more of the memory components such as volatile memory (e.g., DRAM 808), non-volatile memory (e.g., ROM 810), flash memory 812, and the mass storage device may include temporal and/or persistent copies of instructions (e.g., depicted as a control module 846 in FIG. 8) configured to enable computing device 800 to practice disclosed techniques, such as all or selected aspects of method 600 and/or method 700.

The communication chips 806 (labeled communication chip “A” and “B” in FIG. 8) may enable wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Most of the embodiments described herein include WiFi and cellular radio interfaces as examples. However, the communication chip 806 may implement any of a number of wireless standards or protocols, including but not limited to WiMAX, IEEE 802.20, Long Term evolution (“LTE”), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 800 may include a plurality of communication chips 806. For instance, a first communication chip 806 (e.g., Communication Chip A) may be dedicated to shorter range wireless communications such as Wi-Fi and Bluetooth and a second communication chip 806 (e.g., Communication Chip B) may be dedicated to longer range wireless communications such as GPS, EDGE, GPRS, CDMA, WiMAX, LTE, Ev-DO, and others.

In various implementations, the computing device 800 may be a laptop, a netbook, a notebook, an ultrabook, a smart phone, a computing tablet, a personal digital assistant (“PDA”), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 800 may be any other electronic device that processes data.

Embodiments of apparatus, computer-implemented methods, systems, devices, and computer-readable media are described herein for encoding and transmitting layered multi-media streams over multiple radio links. In various embodiments, a first layer of a multi-media stream, such as a base layer of a layered video stream, may be received at a computing device through a first radio link. In various embodiments, a second layer of the multi-media stream, such as an enhancement layer of a layered video stream, may be receive at the computing device through a second radio link. In various embodiments, feedback about the first and second radio links may be transmitted, by the computing device through the first or second radio link, to a remote computing device configured to distribute layers of the multi-media stream among the first and second radio links.

In various embodiments, the remote computing device may be a remote content server configured to encode the multi-media stream. In various embodiments, the first radio link may be between the computing device and a first radio network access node, and the second radio link may be between the computing device and a second radio network access node that is different from the first radio network access node.

In various embodiments, the remote computing device may be a radio network access node. In various embodiments, the radio network access node may be a multi-radio base station configured to communicate with the computing device over the first and second radio links. In various embodiments, the radio network access node may be a multi-radio evolved Node B configured to communicate with the computing device over the first and second radio links.

In various embodiments, receiving a first layer of a multi-media stream may include receiving the first layer of the multi-media stream at a first wireless interface of the computing device having a first Internet Protocol address. In various embodiments, receiving a second layer of a multi-media stream further may include receiving the second layer of the multi-media stream at a second wireless interface of the computing device having a second Internet Protocol address.

In various embodiments, receiving a first layer of a multi-media stream may include receiving the first layer of the multi-media stream at a first wireless interface of the computing device having an Internet Protocol address. In various embodiments, receiving a second layer of a multi-media stream may include receiving the second layer of the multi-media stream at a second wireless interface of the computing device having the same Internet Protocol address.

In various embodiments, the feedback may include one or more of link quality data, quality of experience data or information about capabilities of the computing device. In various embodiments, including those where the multi-media stream is a layered video stream, the feedback may include information about a display resolution supported the computing device, a number of video stream layers requested by the computing device, or a resolution or data rate per layer of the video stream.

In various embodiments, at least one of the first or second layers may be received using RTP. In various embodiments, the feedback may be encoded for transmission using RTCP. In various embodiments, at least one of the first or second layers is received using the H.264 SVC standard.

In various embodiments, the receipt of the first and second layers and transmission of the feedback may together comprise a session. In various embodiments, the session may be initiated using SIP and/or described using SDP. In various embodiments, the first or second layer of the multi-media stream may be received by the computing device using a user datagram control protocol. In various embodiments, the feedback about the first and second radio links may be transmitted by the computing device using a transport control protocol.

In various embodiments, information usable to determine which of the first and second radio links is more reliable may be collected by the computing device. In various embodiments, the collected information may be included, by the computing device, in the feedback.

In various embodiments, the computing device may determine which of the first and second radio links has more bandwidth. In various embodiments, the computing device may include, in the feedback, information about which of the first and second radio links has more bandwidth.

In various embodiments, particularly embodiments where the multi-media stream is a layered video stream, the computing device may generate the feedback to inform the remote computing device about which of the first and second radio links is better suited to receive a base layer of the video stream, and which of the first and second radio links is better suited to receive an enhancement layer of the video stream.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1-65. (canceled)

66. A computer-implemented method, comprising:
receiving, at a computing device through a first radio link, a first layer of a multi-media stream;
receiving, at the computing device through a second radio link, a second layer of the multi-media stream; and
transmitting, by the computing device through the first or second radio link, to a remote computing device configured to distribute layers of the multi-media stream among the first and second radio links, feedback about the first and second radio links.

67. The computer-implemented method of claim 66, wherein the remote computing device is a remote content server configured to encode the multi-media stream.

68. The computer-implemented method of claim 66, wherein the first radio link is between the computing device and a first radio network access node, and the second radio link is between the computing device and a second radio network access node that is different from the first radio network access node.

69. The computer-implemented method of claim 66, wherein the remote computing device is a radio network access node.

70. The computer-implemented method of claim 69, wherein the radio network access node is a multi-radio base station configured to communicate with the computing device over the first and second radio links.

71. The computer-implemented method of claim 69, wherein the radio network access node is a multi-radio evolved Node B configured to communicate with the computing device over the first and second radio links.

72. The computer-implemented method of claim 66, wherein receiving a first layer of a multi-media stream further comprises receiving the first layer of the multi-media stream at a first wireless interface of the computing device having a first Internet Protocol address, and wherein receiving a second layer of a multi-media stream further comprises receiving the second layer of the multi-media stream at a second wireless interface of the computing device having a second Internet Protocol address.

73. The computer-implemented method of claim 66, wherein receiving a first layer of a multi-media stream further comprises receiving the first layer of the multi-media stream at a first wireless interface of the computing device having an Internet Protocol address, and wherein receiving a second layer of a multi-media stream further comprises receiving the second layer of the multi-media stream at a second wireless interface of the computing device having the Internet Protocol address.

74. The computer-implemented method of claim 66, wherein the feedback comprises one or more of link quality data, quality of experience data or information about capabilities of the computing device.

75. The computer-implemented method of claim 66, wherein the feedback comprises information about a display resolution supported the computing device, a number of multi-media stream layers requested by the computing device, or a resolution or data rate per layer of the multi-media stream.

76. The computer-implemented method of claim 66, wherein at least one of the first or second layers is received using the real-time transport protocol (“RTP”), and the feedback is encoded for transmission using the RTP control protocol (“RTCP”).

77. The computer-implemented method of claim 76, wherein the multi-media stream is a layered video stream, and at least one of the first or second layers is received using the H.264 Scalable Video Coding (“SVC”) standard.

78. The computer-implemented method of claim 66, wherein the receipt of the first and second layers and transmission of the feedback together comprise a session, wherein the session is initiated using the Session Initiation protocol (“SIP”) and described using the Session Description Protocol (“SDP”).

79. The computer-implemented method of claim 66, wherein the first or second layer of the multi-media stream is received by the computing device using a user datagram control protocol, and the feedback about the first and second radio links is transmitted by the computing device using a transport control protocol.

80. The computer-implemented method of claim 66, further comprising:
collecting, by the computing device, information usable to determine which of the first and second radio links is more reliable; and
including, by the computing device, in the feedback, the information usable to determine which of the first and second radio links is more reliable.

81. The computer-implemented method of claim 66, further comprising:
determining, by the computing device, which of the first and second radio links has more bandwidth; and
including, by the computing device, in the feedback, information about which of the first and second radio links has more bandwidth.

82. The computer-implemented method of claim 66, wherein the multi-media stream is a layered video stream, and the method further comprises generating, by the computing device, the feedback to inform the remote computing device about which of the first and second radio links is better suited to receive a base layer of the video stream, and which of the first and second radio links is better suited to receive an enhancement layer of the video stream.

83. A system, comprising:
a processor;
a memory operably coupled to the processor;
a first communication interface to a first communication link;
a second communication interface to a second communication link; and
a control module configured to:
receive, through the first communication interface, a first layer of a layered multi-media stream;
receive, through the second communication interface, a second layer of the layered multi-media stream; and
transmit, through the first or second communication interface, to a remote computing device configured to distribute layers of the layered multi-media stream among the first and second communication links, feedback to cause the remote computing device to adjust the distribution of the layers among the first and second communication links.

84. The system of claim 83, wherein the layered multi-media stream comprises a layered video stream, and the feedback comprises information about a display resolution supported the system, a number of video stream layers requested by the system, or a resolution or data rate per layer of the video stream.

85. The system of claim 83, further comprising a touch screen display.

86. A system, comprising:
a processor;
a memory operably coupled to the processor; and
a sender control module configured to:
receive feedback about first and second radio links through which a remote client computing device is configured to receive at least two layers of a video stream;
determine, based on the received feedback, a scheme for distributing at least one base layer and at least one enhancement layer of a video stream among the first and second radio links to the remote client computing device; and
control transmission of the at least one base layer and the at least one enhancement layer of the video stream to the remote client computing device in accordance with the determined scheme.

87. The system of claim 86, wherein the system further comprises:
a first radio interface to the first radio link; and
a second interface to the second radio link;
wherein the sender control module is further configured to transmit, to the remote client computing device, based on the determined scheme, the at least one base layer of the video stream through the first radio interface and the at least one enhancement layer of the video stream through the second radio interface.

88. The system of claim 86, wherein the sender control module is further configured to generate the at least one base layer of the video stream for transmission over the first radio link, and to generate the at least one enhancement layer of the video stream for transmission over the second radio link, in accordance with the determined scheme.

89. The system of claim 86, wherein the sender control module is further configured to determine, based on the received feedback, which of the first and second radio links is better suited for receiving the at least one base layer of the video stream, and which of the first and second radio links is better suited for receiving the at least one enhancement layer of the video stream.

90. The system of claim 86, wherein the sender control module is further configured to utilize an SDP connection descriptor to specify multiple unicast IP addresses for a single RTP session with the client computing device.
